(19) United States
(12) Patent Application Publication
(10) Pub. No.: US 2009/0310201 A1
(43) Pub. Date: Dec. 17, 2009

(54) ELECTROSTATIC ACTUATOR

(75) Inventors: Jun MIZUNO, Tokyo (JP); Naoki KIKUCHI, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/484,472

(22) Filed: Jun. 15, 2009

(30) Foreign Application Priority Data
Jun. 16, 2008 (JP) 2008-156310

(51) Int. Cl. G02B 26/08; H02N 11/00

(52) U.S. Cl. 359/214.1; 310/300

(57) ABSTRACT

An electrostatic actuator as provided having a movable part, a supporter, a first connector, a second connector, first and second connector electrodes, and first and second supporter electrodes. The first and second connector electrodes project respectively from the first and second connectors towards the supporter, and are provided so as to be asymmetrical with respect to a line or a surface passing through the center of mass of the movable part, and which are perpendicular to the first axis. The first and second supporter electrodes project respectively from the supporter towards the first and second connectors, and that are provided so as to be asymmetrical with respect to a line and a surface which pass through the center of mass of the movable part and which are perpendicular to the first axis.

### BACKGROUND OF THE INVENTION

1. Field of the Invention

The present invention relates to an electrostatic actuator that is driven by electrostatic force.

2. Description of the Related Art

An electrostatic actuator for optical scanner comprises a movable part having a mirror, supporters located around the movable part, and connectors connecting the movable part and the supporters. The movable part is swingably connected to the supporters. The connectors are provided on a pivot axis of the movable part.

Movable part electrodes extend from the movable part to the supporters. Supporter electrodes extend from the supporter to the movable part. The movable part electrodes and the supporter electrodes extend alternately towards the axis of the connectors. As seen from the axis of the connectors, distances in the swinging direction are provided between the movable part electrodes and the supporter electrodes. The movable part electrodes and the supporter electrodes make an electrode group. The two electrode groups are provided so as to be line-symmetric to each other with respect to the extending line of the connector.

Japanese Unexamined Patent Publication 2004-13099 discloses that a voltage difference between the movable part electrode and the supporter electrode is created when the movable part swings with respect to the supporter. The voltage difference creates electrostatic power between the movable part electrode and the supporter electrode. Therefore, the movable part electrode and the supporter electrode pull each other by the created electrostatic power, such that the movable part swings with respect to the supporter.

However, if electrodes are provided in the movable past, the weight of the movable part will increase, as a result, the moment of the movable part will also increase, and the movable part may not swing at a very high frequency. Solving this problem requires reduction of the moment of the swinging movable part.

### SUMMARY OF THE INVENTION

An object of the present invention is to provide an electrostatic actuator which can operate efficiently.

The present invention is an electrostatic actuator is provided having a movable part, a supporter, a first connector, a second connector, first and second connector electrodes, and first and second supporter electrodes. The supporter is provided around the movable part. The first connector is provided along a first axis which passes through the movable part and the supporter, and extends from the movable part to the supporter. The first connector allows the movable part to be swingable around the first axis with respect to the supporter. The second connector is provided along the first axis at a different position from the first connector, and which extends from the movable part to the supporter such that the movable part is swingable around the first axis with respect to the supporter. The first and second connector electrodes project respectively from the first and second connectors towards the supporter, and are provided so as to be asymmetrical with respect to a line or a surface passing through the center of mass of the movable part, and which are perpendicular to the first axis. The first and second supporter electrodes project respectively from the supporter towards the first and second connectors, and that are provided so as to be asymmetrical with respect to a line and a surface which pass through the center of mass of the movable part and which are perpendicular to the first axis. The movable part rotates about the main axis of the first and second connectors due to a voltage difference created between the first connector electrode and the first supporter electrode, and between the second connector electrode and the second supporter electrode.

### BRIEF DESCRIPTION OF THE DRAWINGS

The objects and advantages of the present invention will be better understood from the following description, with reference to the accompanying drawings in which:

FIG. 1 is a perspective view showing the front surface of the electrostatic actuator according to the present invention;

FIG. 2 is a perspective view showing the back surface of the electrostatic actuator;

FIG. 3 is a perspective cross-sectional view of the electrostatic actuator taken along line III-III of FIG. 1; and

FIG. 4 in a perspective segmentary magnified cross-sectional view of the electrostatic actuator surrounded with dashed line IV-IV of FIG. 3.

### DESCRIPTION OF THE PREFERRED EMBODIMENTS

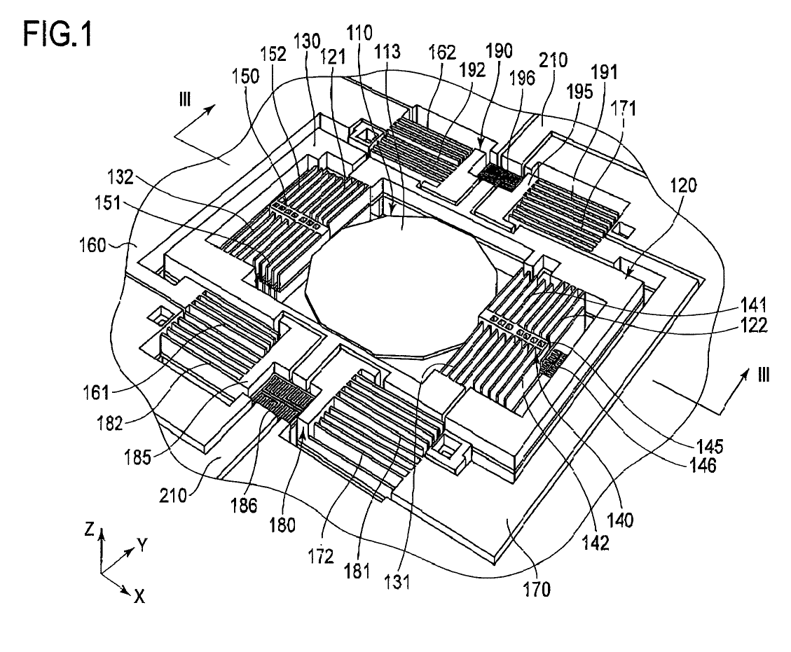

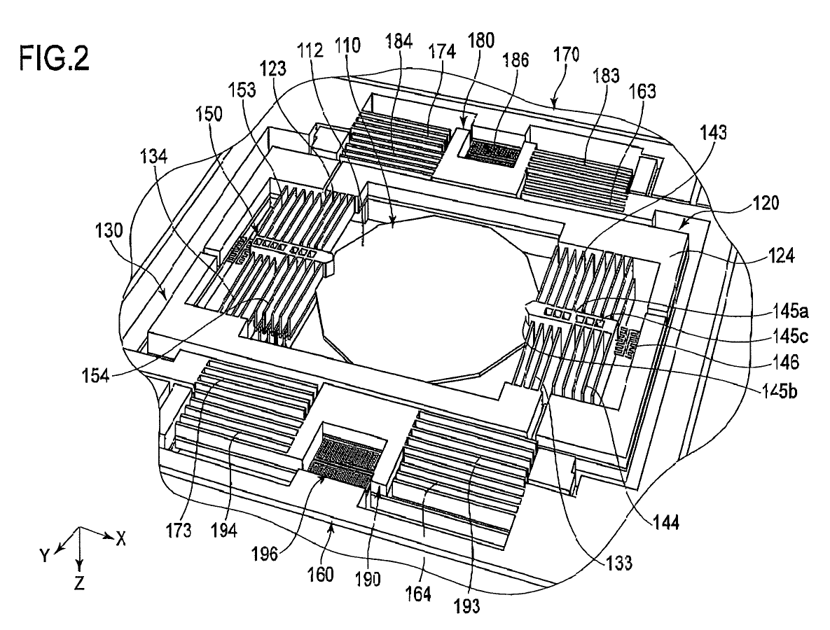

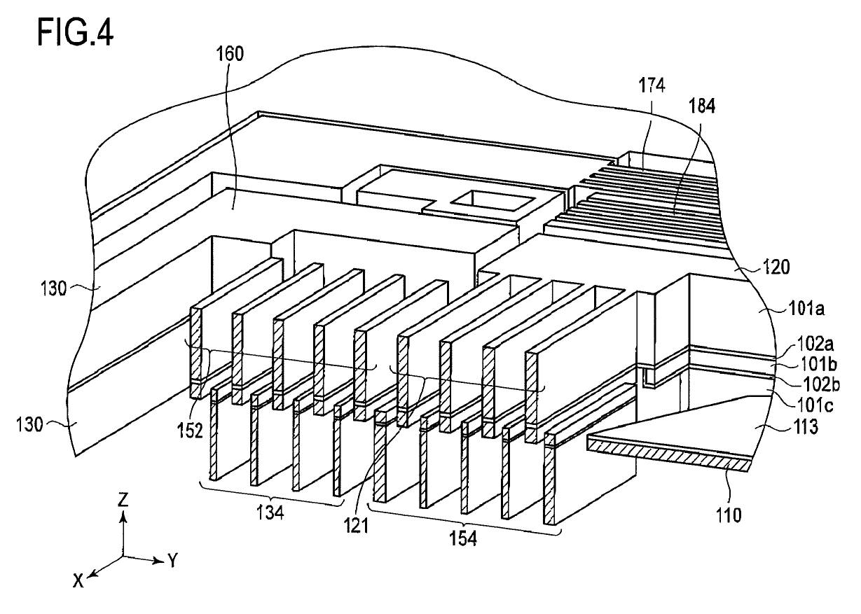

The embodiment of the invention is described below with reference to FIGS. 1 to 4.

The electrostatic actuator 100 comprises a movable part 110 in the form of a regular dodecagon rectangular shape having thickness, an x-positive direction supporter 120 and an x-negative direction supporter 130 which are located around the movable part 110, an x-positive direction connector 140 and an x-negative direction connector 150 which connects the movable part to the x-positive direction supporter 120 and the x-negative direction supporter 130, a y-positive direction supporter 160 and a y-negative direction supporter 170 which are located around the x-positive direction supporter 120 and the x-negative direction supporter 130, a y-positive direction connector 180 and a y-negative direction connector 190 which connect the movable part to the x-positive direction supporter 120 and the x-negative direction supporter 130. In FIG. 1, the extending direction of the x-positive direction connector 140 and the x-negative direction connector 150 is the x axis, the extending direction of the y-positive direction connector 180 and the y-negative direction connector 190 is the y axis, and the swing axis direction of the movable part 110 is the z axis.

The electrostatic actuator 100 is made by etching a substrate which comprises three Si layers 101a, 101b, 101c and two SiO2 layers 102a, 102b which are sandwiched between the three Si layers 101a, 101b, 101c.

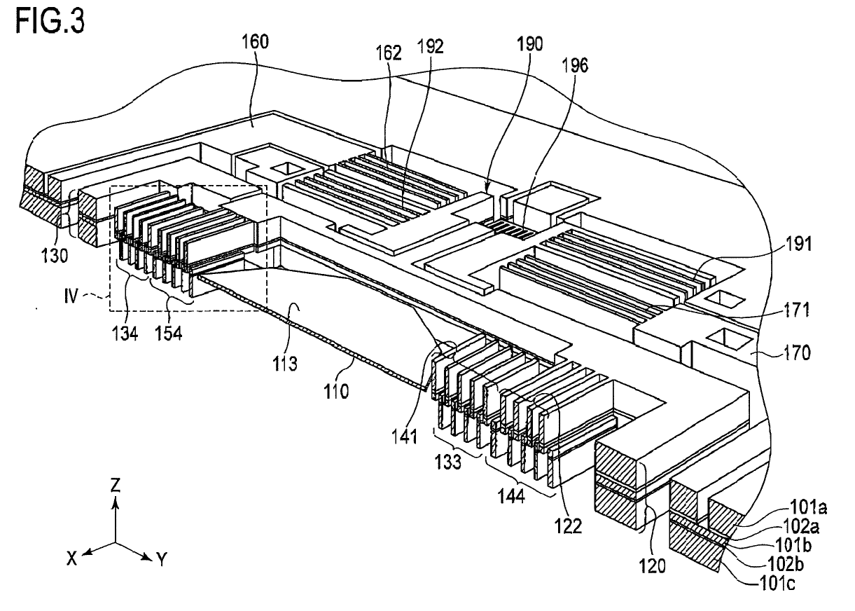

The movable part 110 is made of a center Si layer 101b which is a layer between the three Si layers 101a, 101b, 101c, and an upper SiO2 layer 102a which situates next to the center Si layer 101b. In FIG. 3, the upper SiO2 layer 102a of the movable part 110 is omitted. The center Si layer 101b and the upper SiO2 layer 102a are in the form of a plate. The upper SiO2 layer 102a has a reflecting surface 113 which is a mirror and a rear surface which is the rear of the reflecting surface. The reflecting surface 113 is visible from the outside of the electrostatic actuator 100, and appears in FIG. 1. Hereinafter, all surfaces facing the same direction as the reflecting surface form the scanner front surface; all surfaces facing the opposite direction of the reflecting surface 113 form the scanner rear surface. The scanner front surface is made of an upper Si layer 101a. The scanner rear surface is made of a lower Si layer 101c. From the upper Si layer 101a to the lower Si layer 101c, an upper SiO2 layer 102a, a middle Si layer 101b, and a lower SiO2 layer 102b are sandwiched in sequence between the upper Si layer 101a and the lower Si layer 101c.

The x-positive direction supporter 120 and the x-negative direction supporter 130 have a rectangular tube shape, and a rectangular opening whose face is substantially perpendicular to their thickness direction (i.e. the z axis direction in FIG. 1). Supporter 120 and 130 surround side surfaces of the movable part 110 such that the movable part 110 is in the center of the opening.

Viewed parallel to the thickness direction, the x-positive direction supporter 120 and the x-negative direction supporter 130 have a U-shape which is created by superposing a J-shape which is visible from the scanner front surface, and an inverted J-shape which are visible from the scanner rear surface. The J-shape is formed by cutting two long sides of the opening to ⅕ and ⅘ in the thickness direction of the rectangular tube, and comprises the upper Si layer 101a, the upper SiO2 layer 102a, and the middle Si layer 101b. The inverted J-shape is formed by connecting a ⅘ side of the long side and a ⅗ side of the short side, and comprises the upper SiO2 layer 102a, and the middle Si layer 101b, the lower SiO2 layer 102b, and the lower Si layer 101c. The J-shape of the x-positive direction supporter 120 and the inverted J-shape of the x-negative direction supporter 130 are superposed so as to form a rectangular tube. The inverted J-shape of the x-positive direction supporter 120 and the J-shape of the x-negative direction supporter 130 are superposed so as to form a rectangular tube.

The x-positive direction supporter 120 comprises a first x-positive driving electrode 121 and a second x-positive driving electrode 122 which are visible from the scanner front surface, and a third x-positive driving electrode 123 and a forth x-positive driving electrode 124 which visible from the scanner rear surface. The first x-positive driving electrode 121 extends from the apex of the long side of the J-shape towards the opening. The second x-positive driving electrode 122 extends from the adjacent portion on the long side, to the short side of the J-shape towards the opening. The third x-positive driving electrode 123 extends from the apex of the long side of the inverted J-shape towards the opening. The fourth x-positive driving electrode 124 extends from the adjacent portion on the long side, to the short side of the inverted J-shape towards the opening. The first to fourth x-positive driving electrodes 121-124 comprise respectively four electrode plates. The electrode plates extend parallel to each other in the direction if the width midpoint of the opening, to just short of the width midpoint, and form a comb-like extension.

The x-negative supporter 130 comprises first to fourth x-negative driving electrodes 131-134. The first to fourth x-negative driving electrodes 131-134 are similar to the first-to-fourth x-positive driving electrodes 121-124, therefore the descriptions are omitted.

The x-positive direction connector 140 connects the side surface of the movable part 110 to the x-positive direction supporter 120. The x-negative direction connector 150 connects the side surface of the movable part 110 to the x-negative direction supporter 130. The x-positive direction connector 140 and the x-negative direction connector 150 are aligned along the swing axis of the movable part 110.

The x-positive direction connector 140 comprises an x-positive direction arm 145 which is connected to the movable part 110 and an x-positive direction elastic part 146 which is connected to the x-positive direction supporter 120. The x-positive direction arm 145 comprises a rectangular part 145a which extends in the longitudinal direction of the x-positive direction connector 140 and an x-positive direction keeper 145b which extends towards the rear surface 112 of the movable part 110.

The x-positive direction elastic part 146 is made of the middle Si-layer 101b which repeats winding. Changing repeating times, the elastic modulus of the x-positive direction elastic part 146 may be changed according to design.

The x-positive direction connector 140 comprises first to fourth x-positive ground electrodes 141-144. The first x-positive ground electrode 141 and the second x-positive ground electrode 142 which are visible from the scanner front surface, and made of the upper Si layer 101a, the upper SiO2 layer 102a, and the middle Si layer 101b.

The first x-positive ground electrode 141 extends orthogonally towards the x-positive direction connector 140 and parallel to the y-positive direction from the adjacent portion in the x-positive direction connector 140, towards the movable part 110. The second x-positive ground electrode 142 extends orthogonally towards the x-positive direction connect 140 and parallel in the y-negative direction from the adjacent portion in the x-positive direction connector 140, towards the x-positive direction supporter 120.

The third x-positive ground electrode 143 and the fourth x-positive ground electrode 144 which face from the scanner rear surface, are made of the upper SiO2 layer 102a, the middle Si layer 101b, the lower SiO2 layer 102b, and the lower Si layer 101c.

The third x-positive ground electrode 143 extends orthogonally towards the x-positive direction connector 140 and parallel to the y-negative direction from the adjacent portion in the x-positive direction connector 140 towards the movable part 110. The fourth x-positive ground electrode 144 extends orthogonally towards the x-positive direction connector 140 and parallel to the y-positive direction from the adjacent portion in the x-positive direction connector 140 towards the x-positive direction supporter 120. The first to fourth x-positive ground electrodes 141-144 comprise respectively four electrode plates. The electrode plates extend parallel to each other in the direction if the width midpoint of the opening, to just short of the width midpoint, and form a comb-like extension. The first to fourth x-positive ground electrodes 141-144 are grounded. The rectangular part 145a has walls 145d such that a plurality of holes 145c is provided. The thickness of the walls equals the thickness of the first to fourth x-positive ground electrodes 141-144.

Seen from the longer direction (the x axis direction) of the x-positive direction connector 140, the part made of the upper SiO2 layer 102a and the middle Si layer 101b of the first to fourth x-positive driving electrodes 121-124, and the first to fourth x-positive ground electrodes 141-144, are overlap each other.

The x-negative connector 150 comprises first to fourth x-negative ground electrodes 151-154. The first to fourth x-negative ground electrodes 151-154 and the x-negative connector 150 are similar to the first to fourth x-positive ground electrodes 141-144 and the x-positive connector 140, therefore the descriptions are omitted.

Next, the y-positive direction supporter 160 and the y-negative direction supporter 170 are described.

The y-positive direction supporter 160 and the y-negative direction supporter 170 are provided around the x-positive direction supporter 120 and the x-negative direction supporter 130, and have a rectangular tube shape. The rectangular tube shape surrounds the side surfaces of the x-positive direction supporter 120 and the x-negative direction supporter 130 so as to center them in its opening.

Seen from the thickness direction, the y-positive direction supporter 160 and the y-negative direction supporter 170 have a C-shape which is created by superposing a U-shape which is visible from the scanner front surface, and an inverted L-shape which is visible from the scanner rear surface. The U-shape is formed by cutting two long sides of the opening in half in the thickness direction of the rectangular tube, and comprises the upper Si layer 101a, the upper SiO2 layer 102a, and the middle Si layer 101b. The inverted L-shape is formed by connecting a ⅕ side of the long side and a ⅕ side of the short side, and comprises the upper SiO2 layer 102a, the middle Si layer 101b, the lower SiO2 layer 102b, and the lower Si layer 101c.

The U-shape of the y-positive direction supporter 160 and the inverted L-shape of the y-negative direction supporter 170 are superposed so as to form a rectangular tube. The inverted L-shape of the y-positive direction supporter 160 and the U-shape of the y-negative direction supposed 170 are superposed so as to form a rectangular tube.

The y-positive direction supporter 160 comprises first to fourth y-positive driving electrodes 161-164 respectively made of four electrode plates. The first and second y-positive driving electrodes 161 and 162 are visible from the scanner front surface. The third and fourth y-positive driving electrodes 163, 164 are visible from the scanner rear surface.

The first and second y-positive driving electrodes 161 and 162 extend from the two apexes of the long side of the U-shape towards the y-negative direction supporter 170. The third y-positive driving electrode 163 extends parallel to the x-negative direction from the apex of the short side of the inverted L-shape towards the y-positive direction connector 160. The fourth y-positive driving electrode 164 extends parallel to the long side of the inverted L-shape, i.e., in the x-negative direction, from the adjacent portion on the short side, to the long side of the inverted L-shape towards the y-negative direction supporter 170. The first to fourth y-positive driving electrodes 161-164 extend by short of the opening towards the center of width of the opening.

The y-negative supporter 170 comprises first to fourth y-negative driving electrodes 171-174. The first to fourth y-negative driving electrodes 171-174 are similar to the first to fourth y-positive driving electrodes 161-164, therefore the descriptions are omitted.

The y-negative direction connector 180 connects the side surface of the x-negative direction supporter 130 with the x-negative direction substrate 210. The y-positive direction connector 190 connects the side surface of the x-positive direction supporter 120 with the x-positive direction substrate 220. The y-negative direction connector 180 and the y-positive direction connector 190 consist of the upper Si layer 101a, the upper SiO2 layer 102a, the middle Si layer 101b, the lower SiO2 layer 102b, and the lower Si layer 101c.

The y-negative direction connector 180 comprises a y-negative direction arm 185 which has an inverted C shape seen from the z-positive direction, and a y-negative direction elastic part 186 which is provided on the inner side of the inverted C shape. The y-positive direction connector 190 comprises a y-positive direction arm 195 which has an inverted C shape as seen from the z-positive direction, and a y-positive direction elastic part 196 which is provided on the inner side of the inverted C shape. The y-negative direction connector 180 is line-symmetric to the y-positive direction connector 190 with respect to the line which passes through the x-negative connector 150 and the x-positive connector 140.

The y-positive direction arm 195 is connected to the x-positive supporter 120, and the y-positive direction elastic part 196 is connected to the x-positive substrate 220. The part of y-positive direction arm 195, which is visible from the scanner front surface, is bisected, such that a channel is formed between bisected parts. The x-positive direction supporter 120 extends in the channel to the y-positive direction elastic part 196. The part of the y-positive direction arm 195, which is visible from the scanner rear surface, has an inverted C shape, and consists of the upper SiO2 layer 102a, the middle Si layer 101b, the lower SiO2 layer 102b, and the lower Si layer 101c.

The y-positive direction elastic part 196 consists of the upper SiO2 layer 102a and the middle Si layer 101b which repeat winding. Changing repeating times, the elastic modulus of the y-positive direction elastic part 196 may be changed by design.

The y-positive direction connector 190 comprises first to fourth y-positive ground electrodes 191-194. The first y-positive ground electrode 191 and the second y-positive ground electrode 192 which are visible from the scanner front surface, consist of the upper Si layer 101a, the upper SiO2 layer 102a, and the middle Si layer 101b.

The first y-positive ground electrode 191 extends parallel to the x positive direction from the adjacent portion in the surface of the y-positive direction connector 190, towards the x-negative direction substrate 210. The surface faces the y-negative direction supporter 170. The second y-positive ground electrode 192 extends parallel to the x-negative direction from the adjacent portion in the surface of the y-positive direction connector 190 to the x-negative direction supporter 130. The surface faces the y-positive direction supporter 160.

The third and fourth y-positive ground electrodes 193 and 194 are visible from the scanner rear side, and consist of the upper SiO2 layer 102a, the middle Si layer 101b, the lower SiO2 layer 102b, and the lower Si layer 101c. The third y-positive ground electrode 193 extends parallel to the x-positive direction from the adjacent portion of the y-positive direction connector 190 to the x-negative direction supporter 130. The fourth y-positive ground electrode 194 extends towards the opposite direction of the extending direction of the third y-positive direction ground electrode 193, and parallel to the x-negative direction from the adjacent portion of the y-positive direction connector 190 towards the x-positive direction substrate 220. The surface faces the y-negative direction supporter 170. The first to fourth y-positive ground electrodes 191-194 comprise, respectively, five electrode plates. Each electrode plate extends parallel just short of the facing parts. The first to fourth y-positive ground electrodes 191-194 are grounded.

Seen from the y-positive direction, the part made of the upper SiO2 layer 102a and the middle Si layer 101b of the first to fourth y-positive driving electrodes 161-164 and the first to fourth y-positive ground electrodes 191-194 overlap each other.

The y-negative connector 180 comprises first to fourth y-negative ground electrodes 181-184. The first to fourth y-negative ground electrodes 191-184 are similar to the first to fourth y-positive ground electrodes 191-194, therefore the descriptions are omitted.

The movement of the electrostatic actuator 100 is described hereinafter. Initially, the rotating movement of the movable part 110 around the x axis is described.

When a positive charge is applied to the x-positive substrate 220, the positive charge is conducted to the first to fourth x positive driving electrodes 121-124 through the x-positive direction supporter 120. The positive charge creates electrical potential difference between the first x-positive driving electrode 121 and the second x-positive ground electrode 142, the second x-positive driving electrode 122 and the fourth x-positive ground electrode 144, the third x-positive driving electrode 123 and the first x-negative ground electrode 151, and the fourth x-positive driving electrode 124 and the fourth x-negative ground electrode 154. The electrical potential difference causes electrostatic forces between them such that they attract each other. The first to fourth x-positive driving electrodes 121-124 are thus urged to overlap with the first to fourth x-positive ground electrodes 141-144. In other words, the electrostatic forces work such that the x-positive direction supporter 120, the x-negative direction supporter 130, and the movable part 110 are able to rotate around the axis of the x-positive direction connector 140 and the x-negative direction connector 150, and thus, the x-positive direction connector 140, the x-negative direction connector 150, and the movable part 110 rotate in the x-axis clockwise direction. At such time, the x-positive direction elastic part 146 and the x-negative direction elastic part 156 deform such that the x-positive direction arm 145, the x-negative direction arm 155, and the movable part 110 rotate within a certain angular range.

After the positive charge is removed from the x-positive direction substrate 220, the positive charge is removed through the x-positive direction supporter 120 from the first to fourth x-positive driving electrodes 121-124, such that the electrical potential differences between: the first x-positive driving electrode 121 and the second x-positive ground electrode 142; the second x-positive driving electrode 122 and the fourth x-positive ground electrode 14; the third x-positive driving electrode 123 and the first x-negative ground electrode 151; and the fourth x-positive driving electrode 124 and the fourth x-negative ground electrode 154, are lost. Thus, the electrostatic forces between them disappear. After that, the movable part returns to the position parallel to the scanner front surface by the restorative force created by the x-positive direction elastic part 146 and the x-negative direction elastic port 156.

When a positive charge is applied to the x-negative substrate 210, the positive charge is conducted to the first to fourth x-negative driving electrodes 131-134 through the x-negative direction supporter 130. The positive charge creates an electrical potential difference between: the first x-negative driving electrode 131 and the first x-negative ground electrode 141; the second x-negative driving electrode 132 and the third x-negative ground electrode 143; the third x-negative driving electrode 133 and the second x-negative ground electrode 152; and the fourth x-positive driving electrode 134 and the third x-negative ground electrode 153. The electrical potential difference produces electrostatic forces between the electrode* such that they attract each other. The electrostatic forces work such that the x-positive direction supporter 120, the x-negative direction supporter 130, and the movable part 110 rotate around the axis of the x-positive direction connector 140 and the x-negative direction connector 150. As a result, the x-positive direction connector 140, the x-negative direction connector 150, and the movable part 110 rotate in the direction opposite to the direction in which a positive charge is applied to the x-positive direction substrate 220, in other words, they rotate in the x-axis counter-clockwise direction.

After the positive charge is removed from the x-negative direction substrate 210, the positive charge is removed through the x-negative direction supporter 130 from the first to fourth x-negative driving electrodes 131-134, such that the electrical potential differences between: the first x-negative driving electrode 131 and the first x-negative ground electrode 141; the second x-negative driving electrode 132 and the third x-negative ground electrode 143; the third x-negative driving electrode 133 and the second x-negative ground electrode 152; and the fourth x-positive driving electrode 134 and the third x-negative ground electrode 153, are lost. Thus, the electrostatic forces between them disappear. After that, the movable part returns to the position parallel to the scanner front surface by the restorative force created by the x-positive direction elastic part 146 and the x-negative direction elastic part 156.

Repeating this rotation, the movable part 110 swings around the axis of the x-positive direction connector 140 and the x-negative direction connector 150, such that the reflecting surface 113 may change orientation, and thus the direction in which light shone on the reflecting surface 113 is reflected.

The rotational movement of the movable part 110 around the y axis is next described.

When a positive charge is applied to the y-positive direction supporter 160, the positive charge is conducted to the first to fourth y-positive driving electrodes 161-164. The positive charge creates an electrical potential difference between: the first y-positive driving electrode 161 and the third y-negative ground electrode 183; the second y-positive driving electrode 162 and the fourth y-negative ground electrode 184; the third y-positive driving electrode 163 and the third y-positive ground electrode 193; and between the fourth y-positive driving electrode 164 and the fourth y-positive ground electrode 194. The electrical potential difference produces electrostatic forces between them such that they attract each other. The first to fourth y-positive driving electrodes 161-164 are thus urged to overlap with the third y-negative ground electrode 183, the fourth y-negative ground electrode 184, the third y-positive ground electrode 193, and the fourth y-positive ground electrode 194. In other words, the electrostatic forces work such that the y-positive direction connector 180, the y-negative direction connector 190, and the movable part 110 rotate around the axis of the y-positive direction connector 180 and the y-negative direction connector 190, therefore, the y-positive direction connector 180, the y-negative direction connector 190, and the movable part 110 rotate in the y-axis clockwise direction. At that time, the y-positive direction elastic part 196 and the y-negative direction elastic part 186 deform such that the y-positive direction arm 185, the y-negative direction arm 195, and the movable part 110 rotate within a certain angular range.

After the positive charge is removed from the y-positive direction supporter 160, the positive charge is removed from the first to fourth y-positive driving electrodes 161-164, such that the electrical potential differences between: the first y-positive driving electrode 161 and the third y-negative ground electrode 183; the second y-positive driving electrode 162 and the fourth y-negative ground electrode 184, the third y-positive driving electrode 163 and the third y-positive ground electrode 193; and the fourth y-positive driving electrode 164 and the fourth y-positive ground electrode 194, are lost. Therefore, the electrostatic forces between them disappear. After that, the movable part returns to the position parallel to the scanner front surface by the restorative force created by the y-positive direction elastic part 196 and the y-negative direction elastic part 186.

When a positive charge is applied to the y-negative supporter 170, the positive charge is conducted to the first to fourth y-negative driving electrodes 171-174. The positive charge creates an electrical potential difference between: the first y-negative driving electrode 171 and the first y-negative ground electrode 181; the second y-negative driving electrode 172 and the second y-negative ground electrode 182; the third y-negative driving electrode 173 and the first y-negative ground electrode 191; and the fourth y-positive driving electrode 174 and the second y-negative ground electrode 192. The electrical potential difference causes electrostatic forces between them such that they attract each other. The electrostatic forces work such that the y-positive direction connector 180, the y-negative direction connector 190, and the movable part 110 rotate around the axis of the y-positive direction connector 180, the y-negative direction connector 190. As a result, the y-positive direction connector 180, the y-negative direction connector 190, and the movable part 110 rotate in the direction opposite to the direction in which a positive charge is applied to the y-positive direction supporter 160, in other words, they rotate in the y-axis counter-clockwise direction.

After the positive charge is removed from the y-negative supporter 170, the positive charge is removed from the first to fourth y-negative driving electrodes 171-174, such that the electrical potential between; the first y-negative driving electrode 171 and the first y-negative ground electrode 181; the second y-negative driving electrode 172 and the second y-negative ground electrode 182; the third y-negative driving electrode 173 and the first y-negative ground electrode 191; and the fourth y-positive driving electrode 174 and the second y-negative ground electrode 192, are lost. Thus, the electrostatic forces between them disappear. After that, the movable part returns to the position parallel to the scanner front surface by the restorative force created by the y-positive direction elastic part 196 and the y-negative direction elastic part 186.

Repeating this rotation, the movable part 110 swings around the axis of the y-positive direction connector 180 and the y-negative direction connector 190, such that the reflecting surface 113 may change orientation, and thus the direction of the reflected light which is shone on the reflecting surface 113 is changed.

If the electrostatic actuator 100 is produced by an etching process, the configuration of the electrode plates may imprecise. This error would create imprecision in the electrostatic force between the electrode plates. Therefore, if the electrode plates are arranged regularly, imprecision in the electrostatic forces may have regularity. Such regularity would cause a bias in the electrostatic forces between each electrode plates, such that the electrostatic actuator 100 may not be properly driven, erratic vibrations may be generated, and insufficient torque will result. In this embodiment, the first to fourth x-positive driving electrodes 121-124 are not arranged so as to be line-symmetric with respect to any lines passing through the center of mass of the movable part 110. Therefore, if the electrostatic forces between the electrode plates are irregular, the irregularities are dispersed across the whole of the electrostatic actuator 100, such that each electrostatic actuator 100 will have little error in driving performance and will exhibit stable drive performance. The first to fourth x-positive driving electrodes 121-124, the first to fourth x-negative driving electrodes 131-134, the first to fourth y-positive driving electrodes 161-164, and the first to fourth y-negative driving electrodes 171-174 have the same advantageous effect.

Note that, the electrical charge applied to the supporter electrodes may be positive electrical charge or negative electrical charge.

Although the embodiment of the present invention has been described herein with reference to the accompanying drawings, obviously many modifications and changes may be made by those skilled in the art without departing from the scope of the invention.

The present disclosure relates to subject matter contained in Japanese Patent Application No. 2008-156310 (filed on Jun. 16, 2008), which is expressly incorporated herein, by reference, in its entirety.

1. An electrostatic actuator comprising:
a movable part;
a supporter that is provided around said movable part;
a first connector that is provided along a first axis which passes through said movable part and said supporter, and extends from said movable part to said supporter, said first connector allowing said movable part to be swingable around the first axis with respect to said supporter;
a second connector that is provided along the first axis at a different position from said first connector, and which extends from said movable part to said supporter such that said movable part is swingable around the first axis with respect to said supporter;
first and second connector electrodes that project respectively from said first and second connectors towards said supporter, and are provided so as to be asymmetrical with respect to one of a line and a surface which passes through the center of mass of said movable part, and which is perpendicular to the first axis; and
first and second supporter electrodes that project respectively from said supporter towards said first and second connectors, and are provided so as to be asymmetrical with respect to one of a line and a surface which passes through the center of mass of said movable part and which is perpendicular to the first axis;
said movable part rotating about the main axis of the first and second connectors due to a voltage difference created between said first connector electrode and said first supporter electrode, and between said second connector electrode and said second supporter electrode.

2. The electrostatic actuator according to claim 1, wherein said first and second connectors, respectively, have first and second arms which are connected to said movable part, and respectively, have first and second elastic parts which connect said supporter and the first and second arms; and wherein said first and second connector electrodes respectively project from the first and second arms.

3. The electrostatic actuator according to claim 1, wherein said first and second supporter electrodes respectively overlap with parts of said first and second connector electrodes as seen from the axes of said first and second connectors.

4. The electrostatic actuator according to claim 1, wherein said first supporter electrode projects towards the movable-part end of said first connector, and said second supporter electrode projects towards the supporter end of said second connector.

5. The electrostatic actuator according to claim 4, wherein said first connector electrode projects from the movable-part end of said first connector, and said second connector electrode projects from the supporter end of said second connector.

6. The electrostatic actuator according to claim 5, wherein
said first supporter electrode has a first supporter front-side electrode which projects from said supporter towards the movable-part end of said first connector, and has a first supporter rear-side electrode which projects from a surface of said supporter which opposes another surface of said supporter from which the first supporter front-side electrode projects towards the movable-part end of said first connector, and
said second supporter electrode has a second supporter front-side electrode which projects from said supporter towards the supporter end of said second connector, and has a second supporter rear-side electrode which projects from a surface of said supporter which opposes another surface of said supporter from which the second supporter front-side electrode projects towards the supporter end of said second connector.

7. The electrostatic actuator according to claim 1, wherein said first supporter electrode projects towards the supporter end of said first connector, and said second supporter electrode projects towards the movable-part end of said second connector.

8. The electrostatic actuator according to claim 7, wherein said first connector electrode projects from the supporter end of said first connector, and said second connector electrode projects from the movable-part end of said second connector.

9. The electrostatic actuator according to claim 8, wherein
said first supporter electrode has a first supporter front-side electrode which projects from said supporter towards the supporter end of said first connector, and has a first supporter rear-side electrode which projects from a surface of said supporter which opposes another surface of said supporter from which the first supporter front-side electrode projects towards the supporter end of said first connector, and
said second supporter electrode has a second supporter front-side electrode which projects from said supporter towards the movable-part end of said second connector, and has a second supporter rear-side electrode which projects from a surface of said supporter which opposes another surface of said supporter from which the second supporter front-side electrode projects towards the movable-part end of said second connector.

10. The electrostatic actuator according to claim 1, wherein
said supporter has a first supporter and a second supporter,
the first supporter and the second supporter have substantially same shape, and are provided symmetrically with respect to an axis which is perpendicular to the front surface of the movable part,
said first supporter electrode projects towards the movable-part end of said first connector,
said second supporter electrode projects towards the first supporter end of said second connector,
said third supporter electrode projects towards the second supporter end of said first connector,
said fourth supporter electrode projects towards the movable-part end of said second connector,
said first connector electrode projects from the movable-part end of said first connector,
said second connector electrode projects from the first supporter end of said second connector,
said third connector electrode projects from the second supporter end of said first connector,
said fourth connector electrode projects from the movable-part end of said second connector,
said first supporter electrode has a first supporter front-side electrode which projects from the first supporter towards the movable-part end of said first connector, and has a first supporter rear-side electrode which projects from a surface of the first supporter which opposes another surface of the first supporter from which the first supporter front-side electrode projects towards the movable-part end of said first connector,
said second supporter electrode has a second supporter front-side electrode which projects from the first supporter towards the first supporter end of said second connector, and has a second supporter rear-side electrode which projects from a surface of the first supporter which opposes another surface of the first supporter from which the second supporter front-side electrode projects towards the first supporter end of said second connector,
said third supporter electrode has a third supporter front-side electrode which projects from the second supporter towards the second supporter end of said first connector, and has a third supporter rear-side electrode which projects from a surface of the second supporter which opposes another surface of the second supporter from which the third supporter front-side electrode projects towards the second supporter end of said first connector, and
said fourth supporter electrode has a fourth supporter front-side electrode which projects from the second supporter towards the movable-part end of said second connector, and has a fourth supporter rear-side electrode which projects from a surface of the second supporter which opposes another surface of the second supporter from which the fourth supporter front-side electrode projects towards the movable-part end of said second connector.

11. The electrostatic actuator according to claim 1, wherein a plurality of said first connector electrode and a plurality of said second connector electrode are aligned so as to be perpendicular to said first connector and said second connector, and said first supporter electrodes and said second supporter electrodes are aligned alternately.

12. The electrostatic actuator according to claim 1, wherein said movable part has the form of a plate.

13. The electrostatic actuator according to claim 12, wherein
said movable part has a reflecting surface which reflects light and a back surface which is the rear of the reflecting surface, and
the reflecting surface is a flat surface which is parallel to the long axis of said connector and parallel to the projecting direction of said first and second supporter electrodes and said first and second connector electrodes.

14. The electrostatic actuator according to claim 1, wherein
said movable part and said supporter have a front conductor layer, a center conductor layer, and a rear conductor layer which overlap in their thickness direction, and
said first and second connectors are formed of the front conductor layer, the center conductor layers and the rear conductor layer.

15. The electrostatic actuator according to claim 14, wherein said first and second connector electrodes are formed of the center conductor layer, and either the front conductor layer or the rear conductor layer.

16. The electrostatic actuator according to claim 15, wherein said first and second supporter electrodes are formed of the center conductor layer, and either the front conductor layer or the rear conductor layer.
